(19) United States
(12) Patent Application Publication
(10) Pub. No.: US 2018/0338294 A1
(43) Pub. Date: Nov. 22, 2018

(54) WIRELESS COMMUNICATION DEVICE AND ROAMING NETWORK REGISTRATION METHOD

(71) Applicant: ASUSTeK COMPUTER INC., TAIPEI (TW)

(72) Inventors: Cheng-Hsin LIN, TAIPEI (TW); Wei-Hao CHEN, TAIPEI (TW); Chia-Jung HSIAO, TAIPEI (TW)

(21) Appl. No.: 15/979,839

(22) Filed: May 15, 2018

(30) Foreign Application Priority Data
May 19, 2017 (TW) 106116752

(51) Int. Cl. H04W 60/00; H04W 48/16

(52) U.S. Cl. CPC H04W 60/00; H04W 84/042; H04W 48/16

(57) ABSTRACT

A roaming network registration method executed via a wireless communication device is provided. The method comprises the following steps: executing a search in a latest registered supported network type of a plurality of supported network types based on a first database; obtaining a first mobile country code transmitted via at least one public land mobile network when the public land mobile network is searched; comparing the first mobile country code with a second mobile country code corresponding to a latest registered public land mobile network of the wireless communication device; and determining that the wireless communication device is in a roaming state when the first mobile country code is different from second mobile country code.

### CROSS-REFERENCE TO RELATED APPLICATION

This application claims the priority benefit of TW application serial No. 106116752, filed on May 19, 2017. The entirety of the above-mentioned patent application is hereby incorporated by references herein and made a part of specification.

### BACKGROUND OF THE INVENTION

### Field of the Invention

The disclosure relates to a wireless communication device and a roaming network registration method.

### Description of the Related Art

A wireless communication device, such as a smart phone, a tablet is widely used. When the wireless communication device is taken to other countries, it needs to be changed to a roaming state and be connected to a local base station and public land mobile network (PLMN) to have a network service.

Conventionally, the wireless communication device needs long time for a full scanning program to confirm the roaming state of the wireless communication device. Then, the wireless communication device usually needs to repeatedly try the registration of the local public land mobile network. The time for the registration in the roaming state may be several minutes, which is rather inconvenient.

### BRIEF SUMMARY OF THE INVENTION

According to the first aspect of the disclosure, a roaming network registration method executed via a wireless communication device is provided. The method comprises: executing a search in a latest registered supported network type of a plurality of supported network types based on a first database; obtaining a first mobile country code transmitted via at least one public land mobile network when the public land mobile network is searched; comparing the first mobile country code with a second mobile country code corresponding to a latest registered public land mobile network of the wireless communication device; and determining that the wireless communication device is in a roaming state when the first mobile country code is different from second mobile country code.

According to the second aspect of the disclosure, a wireless communication device is provided. The wireless communication device comprises: a first database configured to store one or more frequency bands of a public land mobile network; a second database configured to store one or more registered public land mobile networks of the wireless communication device; a memory configured to store multiple executable instructions; a processor coupled with the first database, the second database and the memory and configured to execute the executable instructions stored in the memory; wherein the executable instructions stored in the memory includes: executing a search in a latest registered supported network type of a plurality of supported network types based on a first database; obtaining a first mobile country code transmitted via at least one public land mobile network when the public land mobile network is searched; comparing the first mobile country code with a second mobile country code corresponding to a latest registered public land mobile network of the wireless communication device; and determining that the wireless communication device is in a roaming state when the first mobile country code is different from second mobile country code.

These and other features, aspects and advantages of the present invention will become better understood with regard to the following description, appended claims, and accompanying drawings.

### BRIEF DESCRIPTION OF THE DRAWINGS

FIG. 1 is a schematic view showing a wireless communication system according to an embodiment.

FIG. 2 is a flow chart of a roaming network registration method executed by a wireless communication device according to an embodiment.

FIG. 3 is a flow chart of detailed steps of a roaming network registration method according to an embodiment.

FIG. 4 is a flow chart of detailed steps of a roaming network registration method according to an embodiment.

### DETAILED DESCRIPTION OF THE EMBODIMENTS

When a component is “connected” or “coupled” to another component, it represents that the component is “electrically connected” or “electrically coupled” to another component. It also represents that two or more components operate or interact with each other. Moreover, although the terms “the first”, “the second” and so on are used in the disclosure, they are only used to distinguish components or operations with same terms. They are not used to limit the order or limit the invention except that they are specifically indicated in the context.

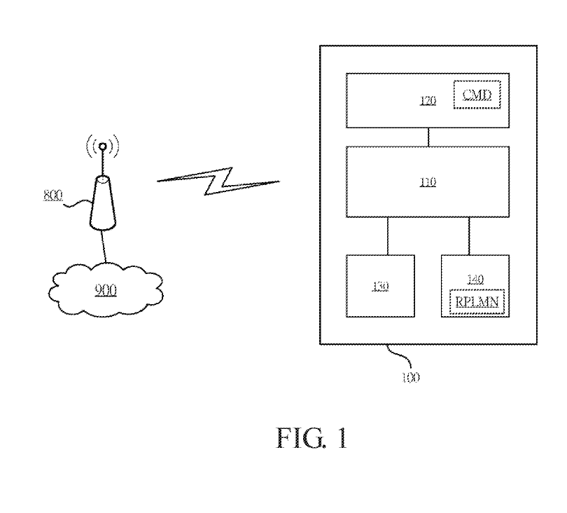

Please refer to FIG. 1. FIG. 1 is a schematic view showing a wireless communication system according to an embodiment. As shown in FIG. 1, a wireless communication system includes a wireless communication device 100, a base station 800 and a public land mobile network 900. Each telecom operator can configure telephone network to construct public land mobile network. The wireless communication device 100 is communicated with the base station 800 and the public land mobile network 900. The number of the base stations 800 and that of the public land mobile networks 900 are not limited to those shown in FIG. 1.

In the embodiment, the wireless communication device 100 includes a processor 110, a memory 120, a first database 130 and a second database 140. In an embodiment, the first database 130 and the second database 140 is a storage unit, a memory or other component for data store. Multiple executable instructions CMD are stored in the memory 120. The processor 110 is coupled to the memory 120, the first database 130 and the second database 140. The processor 110 is configured to execute the executable instructions CMD stored in the memory 120.

One or more frequency bands of public land mobile networks are stored in the first database 130. In an embodiment, a public land mobile networks identifier (PLMN identifier, PLMN ID) with a high opportunity to obtain services for the wireless communication device 100, one or more frequency bands of the public land mobile networks, and other related data necessary for searching the database are stored in the first database 130.

In an embodiment, the data in the first database 130 is preconfigured by a user of a wireless service provider relevant to the wireless communication device 100, a manufacturer of the wireless communication device 100 or a network operator, etc. In an embodiment, the data in the first database 130 is adjusted or updated dynamically by the user of the wireless service provider or the network operator. Therefore, the wireless communication device 100 executes a database search based on the first database 130. The searching efficiency is improved, and the search time is reduced.

One or more registered public land mobile networks (RPLMN) registered by the wireless communication device 100 are stored in the second database 140. Therefore, the wireless communication device 100 obtains one or more registered public land mobile networks registered by the wireless communication device 100 from the second database 140. Then, the wireless communication device 100 obtains a network operator candidate list.

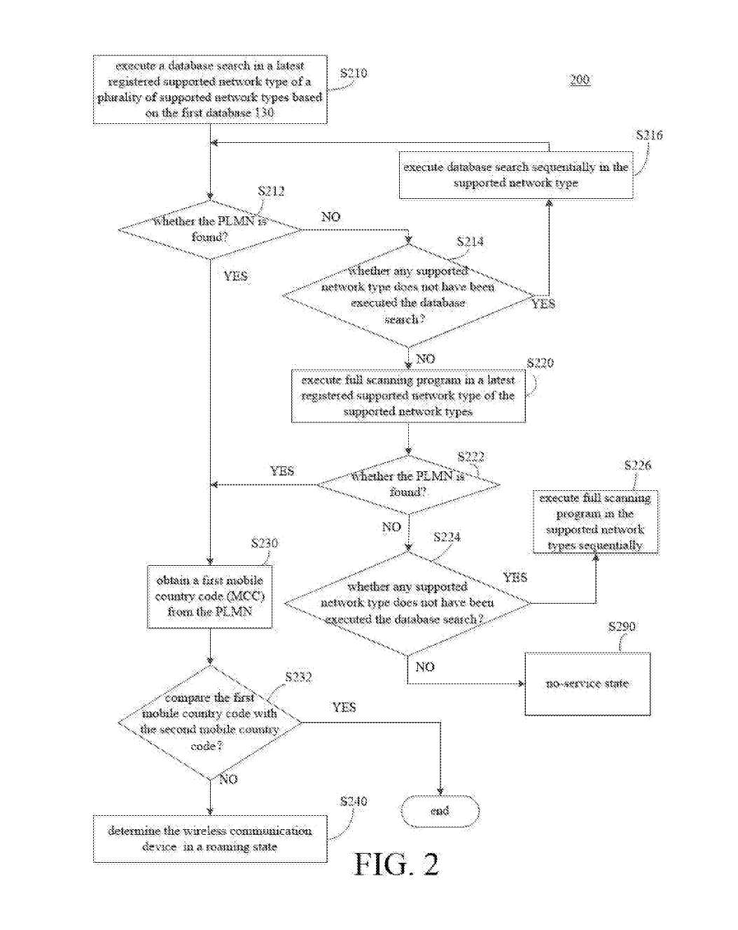

In an embodiment, after the wireless communication device 100 is powered on, the processor 110 executes a roaming network registration method 200 by executing executable instructions CMD stored in the memory 120 with the cooperation of the first database 130 and second database 140. Please refer to FIG. 2. FIG. 2 is a flow chart of a roaming network registration method 200 executed by a wireless communication device 100 according to an embodiment.

As shown in FIG. 2, in the embodiment, the roaming network registration method 200 includes steps S210, S212, S214, S216, S220, S222, S224, S226, S230, S232, S240 and S290.

First, in step S210, the processor 110 controls the wireless communication device 100 to execute a database search in a latest registered supported network type of a plurality of supported network types based on the first database 130. In an embodiment, the wireless communication device 100 can support 2G network, 3G network, 4G network, etc. In step S210, the wireless communication device 100 executes the database search in the latest registered supported network type (for example, 4G network), and tries to communicate with the public land mobile network more likely to acquire services according to data stored in the first database 130. In an embodiment, the wireless communication device 100 executes a database search in the latest registered supported network type (for example, 4G network) and the latest registered public land mobile network.

In step S212, the processor 110 determines whether the wireless communication device 100 is successful communicated with the base station in step S210, and obtains the corresponding public land mobile network.

When the wireless communication device 100 does not obtain the network service from the database search that executed in the latest registered supported network type (for example, 4G network), the processor 110 executes steps S214 and S216. In steps S214 and S216, the processor 110 executes database search sequentially in each supported network type (for example, 3G network, 2G network) based on the first database 130 until one or more public land mobile networks are obtained.

In step S214, the processor 110 determines whether any supported network type does not have been executed the database search. If some supported network type does not have been executed the database search, step S216 is executed. In step S216, the processor 110 executes database search sequentially in the supported network type.

The processor 110 repeats the above steps until all of the supported network types are already searched. When no network service is obtained from the database search that executed in all supported network types, the processor 110 executes step S220. In step S220, processor 110 executes full scanning program in a latest registered supported network type of the supported network types until one or more public land mobile networks are obtained.

In step S222, the processor 110 determines whether the wireless communication device 100 successfully communicates with the base station in step S220, and obtains the corresponding public land mobile network.

When no network service is obtained from the full scanning program that executed in the latest registered supported network type, the processor 110 executes steps S224 and S226. In steps S224 and S226, the processor 110 controls the wireless communication device 100 to execute full scanning program sequentially in each supported network type until one or more public land mobile networks are obtained.

In step S224, then processor 110 determines whether any supported network type does not have been executed the database search. If some supported network type does not have been executed the database search, step S226 is executed. In step S226, the processor 110 executes full scanning program in the supported network types sequentially.

The processor 110 repeats the above steps until all of the supported network types are already full scanned. When no network service is obtained from the full scanning program that executed in all supported network types, the processor 110 executes step S290 to make the wireless communication device 100 into a no-service state.

When the wireless communication device 100 obtains one or more public land mobile networks from searching results of any period of the database search or the full scanning program in the above steps, the processor 110 executes step S230.

In step S230, the processor 110 obtains a first mobile country code (MCC) from the public land mobile network. In an embodiment, when the wireless communication device 100 communicates with the public land mobile network, a public land mobile network identifier (PLMN ID) is obtained. The public land mobile network identifier includes a mobile country code (MCC) and a mobile network code (MNC). The country code is configured to identify the country of the network service. The mobile network code is configured to identify the provider of the public land mobile network.

In step S232, the processor 110 compares the first mobile country code with the second mobile country code corresponding to the latest registered public land mobile network of the wireless communication device 100.

When the first mobile country code received by the wireless communication device 100 is different from the second mobile country code corresponding to the latest registered public land mobile network, the processor 110 executes step S240. In step S240, the wireless communication device 100 is determined to be in a roaming state, and an optimization program is executed to accelerate the speed of registering network in the roaming state.

Therefore, as soon as the wireless communication device 100 obtains the provider of any public land mobile network, the wireless communication device 100 immediately determines whether the wireless communication device 100 is in a roaming state. Then time for determining the roaming state is reduced.

When the first mobile country code received presently by the wireless communication device 100 is the same as the second mobile country code corresponding to the latest registered public land mobile network, the processor 110 determines that the wireless communication device 100 is not in a roaming state.

Therefore, no optimization is needed. Then, the wireless communication device 100 communicates with the searched base station and the searched public land mobile network as unusual.

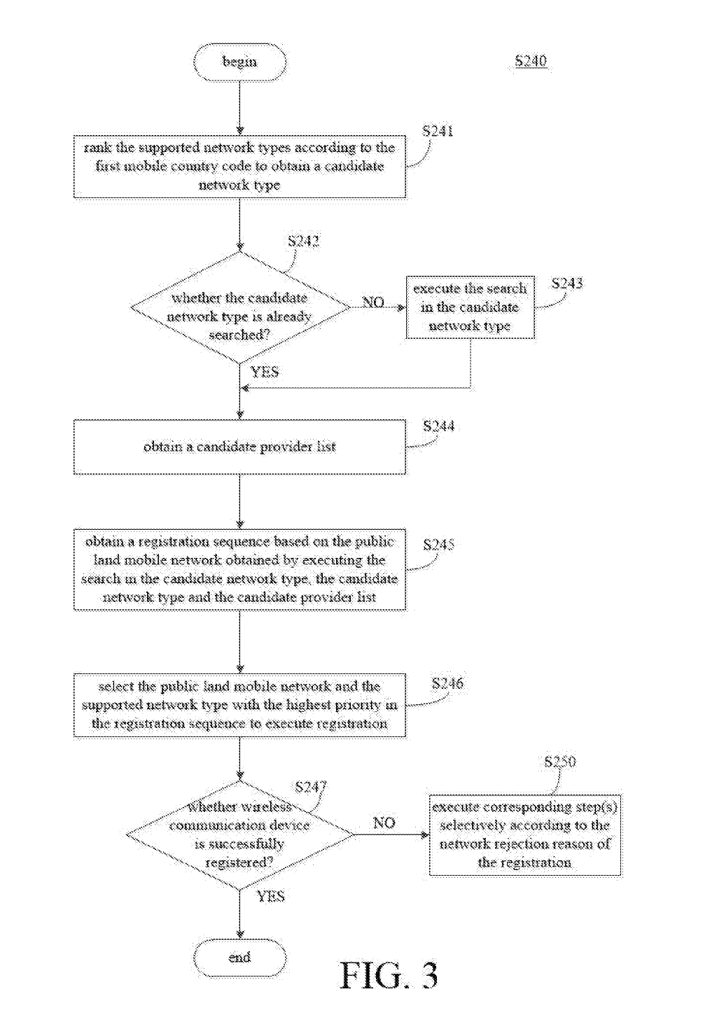

Please refer to FIG. 3. FIG. 3 is a flow chart of detail steps of step S240 of a roaming network registration method 200 according to an embodiment. As shown in FIG. 3, in the embodiment, step S240 further includes steps S241, S242, S243, S244, S245, S246, S247 and S250.

In step S241, the processor 110 ranks the supported network types according to the first mobile country code to obtain a candidate network type. Therefore, the wireless communication device 100 selects a network type more with a higher opportunity to obtain services as the candidate network type according to a usage condition of each network type in different countries. In an embodiment, the processor 110 determines that the wireless communication device 100 is in Japan according to the first mobile country code. Since 4G network is widely used in Japan, the 4G network has a higher priority to be used as the candidate network type. In contrast, since 2G network service is already not provided in Japan, the processor 110 sets 2G network with a lower priority in the rank. Moreover, since Time Division-Synchronous Code Division Multiple Access (TD-SCDMA) in 3G communication standard are only used in China, the processor 110 sets TD-SCDMA with a lower priority in the rank in other countries except China.

In step S241, the processor 110 determines possibilities of obtaining networks services according to the popularities of different networks in the countries and areas of the wireless communication device 100, and ranks according to the possibilities to obtain a candidate network type (for example 4G network). Then, the candidate network type has a higher priority to be tried in the registration. Therefore, when the wireless communication device 100 is in the roaming state, the higher priority network type is processed preferentially, and then the network service can be obtained more quickly.

In step S242, the processor 110 determines whether the candidate network type is already searched in previous steps. When the candidate network type is not searched yet, the processor 110 executes the search in the candidate network type in step S243.

When the candidate network type is already searched, step S244 is executed. In step S244, the processor 110 obtains one or more registered public land mobile networks (RPLMN) of the wireless communication device 100 from the second database 140. Then, a candidate provider list is obtained based on the one or more registered public land mobile networks (RPLMN) obtained from the second database 140.

In step S245, the processor 110 obtains a registration sequence based on the public land mobile network obtained by executing the search in the candidate network type, the candidate network type and the candidate provider list. Therefore, the wireless communication device 100 determines the public land mobile network which is most likely successfully registered from the candidate provider list to register in the following steps.

In step S246, the processor 110 selects the public land mobile network and the supported network type with the highest priority in the registration sequence obtained in step S245 to execute registration.

In an embodiment, the processor 110 selects 4G network as the candidate network type according to the location (for example, Japan), and obtains the public land mobile networks of telecom operators A, B, and C from the searching result. The telecom operate B is a registered public land mobile network (RPLMN) which succeeds in obtaining services for the wireless communication device 100 in the past. Then, the processor 110 ranks the 4G network service provided by the telecom operator B with the highest priority in the registration sequence. Then, the wireless communication device 100 preferably tries to register the telecom operator B to obtain the network service.

Therefore, the wireless communication device 100 ranks the preferred network types effectively according to a network provider list in the second database 140. The possibility of obtaining available the network provider is improved, and the speed of obtaining the network service is accelerated.

In step S247, the processor 110 determines whether wireless communication device 100 is successfully registered. When the wireless communication device 100 is successfully registered the roaming network and obtains the network service, the optimization process is ended. On the other hand, when the processor 110 determines that the wireless communication device 100 fails in the registration, step S250 is executed. In step S250, the processor 110 executes corresponding step(s) selectively according to the network rejection reason of the registration when the wireless communication device fails in the registration.

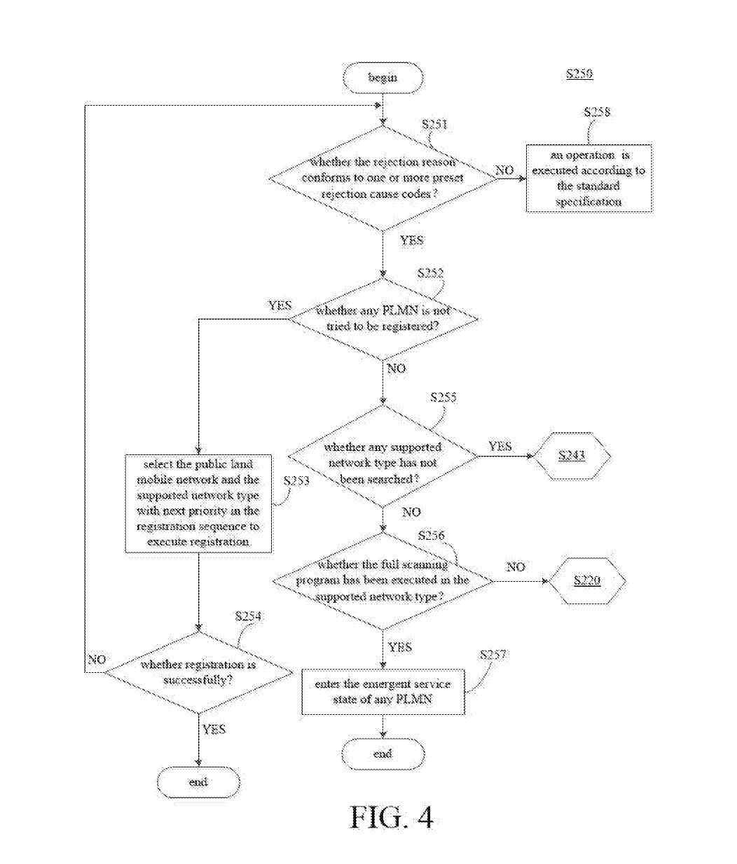

Please refer to FIG. 4. FIG. 4 is a detailed flow chart of step 250 of a roaming network registration method 200 according to an embodiment. As shown in FIG. 4, in the embodiment, step S250 further includes step S251 to step S258.

In step S251, the processor 110 determines whether the rejection reason conforms to one or more preset rejection cause codes. If not, the processor 110 executes step S258 and operates according corresponding standard specification.

In an embodiment, when the registration fails, the public land mobile network transmits back the rejection cause code of 3rd Generation Partnership Project (3GPP) standard specification. The processor 110 presets that step S252 is executed when the rejection cause code #17 (Network Failure) or the rejection cause code #13 (Roaming not allowed in this LA) is obtained. Otherwise, in step S258, an operation for the rejection cause code is executed according to 3GPP standard specification.

Therefore, for the rejection cause code #13 and the rejection cause code #17, the wireless communication device 100 tries the public land mobile network of next candidate telecom operator. Then, the time for obtaining the available network is saved. Consequently, the wireless communication device 100 does not need to repeatedly try to register according to 3GPP standard specification or re-executes the full 2G/3G/4G scanning, which is time-saving.

In step S252, the processor 110 determines whether any public land mobile network is not tried to be registered. If yes, in step S253, the processor 110 selects the public land mobile network and the supported network type with next priority in the registration sequence to execute registration.

Similar to step S247, in step S254, the processor 110 determines whether the wireless communication device 100 is successfully registered this time. When the wireless communication device 100 is successfully registered in the roaming network and obtains the network service, the optimization process is ended. Otherwise, when the processor 110 determines that the wireless communication device 100 fails in registration, step S250 is executed. In step S250, the processor 110 executes corresponding step(s) selectively according to the network rejection cause obtained when the registration fails.

In an embodiment, when the telecom operator B with the highest priority fails in the registration, the processor 110 determines that telecom operators A and C are still available for registration. Then, the wireless communication device 100 registers in the public land mobile networks provided via the telecom operator A and C operator sequentially until the registration is successful or the registration fails in all of the public land mobile networks.

When the registration fails in all of the public land mobile networks, and no public land mobile network is available for registration, the processor 110 executes step S255. In step S255, the processor 110 determines whether any supported network type has not been searched. If yes, step S243 is executed. Then, a new registration sequence is obtained for the registration.

In an embodiment, when the registration in 4G network services provided by telecom operators A, B and C fails, the processor 110 determines that 3G network service is not searched yet. Then, the processor 110 searches 3G network service which is regarded as a new candidate network type. Then, a candidate provider list is obtained, and the registration sequence is obtained.

When all supported network types are already searched and no registration is successful in all public land mobile network of supported network types, the processor 110 executes step S256. In step S256, the processor 110 determines whether the full scanning program has been executed in the supported network type, that is, whether steps S220˜S226 are executed. When the wireless communication device 100 does not execute the full scanning program for all supported network types, step S220 is executed. In step S220, the full scanning program is executed to try to communicate with the public land mobile network which cannot be obtained via other database search.

In step S256, when the processor 110 determines that the wireless communication device 100 already executes the full scanning program in each supported network type, the registration in each public land mobile network which can be communicated is determined to fail. Then, the processor 110 executes step S257. In step S257, the wireless communication device enters an emergent service state of any public land mobile network.

Although the roaming network registration method 200 in the present disclosure is described as a series of steps or events, it should be understood that the shown sequence of these steps or events is not limited to the disclosed sequence. Moreover, in one or more embodiments of the present disclosure, not all shown steps are necessary. Furthermore, one or more step of the present disclosure can be executed in one or more separate steps or stages.

In sum, the executable instructions CMD stored in the memory 120 can be executed via the processor 110 of the wireless communication device 100 with the cooperation of data stored in the first database 130 and the second database 140. The wireless communication device 100 executes the roaming network registration method 200 to determine whether it is in the roaming state more quickly. Network available for registration in roaming state is searched. Since unnecessary searches are reduced, the searching efficiency is improved greatly, and the time for searching is reduced.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A roaming network registration method executed via a wireless communication device, comprising:
executing a search in a latest registered supported network type of a plurality of supported network types based on a first database;
obtaining a first mobile country code transmitted via at least one public land mobile network when the public land mobile network is searched;
comparing the first mobile country code with a second mobile country code corresponding to a latest registered public land mobile network of the wireless communication device; and
determining that the wireless communication device is in a roaming state when the first mobile country code is different from second mobile country code.

2. The roaming network registration method according to claim 1, further comprising:
ranking the supported network types according to the first mobile country code to obtain a candidate network type after determining that the wireless communication device is in the roaming state;
obtaining a candidate provider list based on the at least one registered public land mobile networks of the wireless communication device obtained from a second database ;
obtain a registration sequence based on at least one public land mobile networks obtained by executing a search in the candidate network type, the candidate provider list and the candidate network type while executing the search in the candidate network type is finished; and
selecting the public land mobile network and the supported network type with a highest priority in the registration sequence to execute the registration.

3. The roaming network registration method according to claim 2, further comprising:
executing a search in the candidate network type when the candidate network type has not been searched, and obtaining the registration sequence based on the public land mobile network obtained by executing the search in the candidate network type, the candidate provider list and the candidate network type.

4. The roaming network registration method according to claim 2, further comprising:
selectively executing a corresponding step according to a rejection reason of the registration when the wireless communication device fails in the registration;
sequentially selecting next one of the public land mobile network and the supported network type to execute the registration according to the registration sequence when the rejection reason conforms to a preset rejection cause code; and
executing an operation according to a standard specification when the rejection reason does not conform to the preset rejection cause code.

5. The roaming network registration method according to claim 1, further comprising:
executing a database search sequentially in the supported network types based on the first database until the public land mobile network is obtained, when no network service is obtained from the database search that executed in the latest registered supported network type.

6. The roaming network registration method according to claim 5, further comprising:
executing a full scanning program in the latest registered supported network type of the supported network types until the public land mobile network is obtained when no network service is not obtained from the database search that executed in the supported network types.

7. The roaming network registration method according to claim 6, further comprising:
executing a full scanning program sequentially in the supported network types until the public land mobile network is obtained when no network service is obtained from the full scanning program that executed in the latest registered supported network type.

8. A wireless communication device, comprising:
a first database configured to store one or more frequency bands of a public land mobile network;
a second database configured to store one or more registered public land mobile networks of the wireless communication device;
a memory configured to store a plurality of executable instructions; and
a processor coupled with the first database, the second database and the memory and configured to execute the executable instructions stored in the memory;
wherein the executable instructions stored in the memory includes:
executing a search in a latest registered supported network type of a plurality of supported network types based on a first database;
obtaining a first mobile country code transmitted via at least one public land mobile network when the public land mobile network is searched;
comparing the first mobile country code with a second mobile country code corresponding to a latest registered public land mobile network of the wireless communication device; and
determining that the wireless communication device is in a roaming state when the first mobile country code is different from second mobile country code.

9. The wireless communication device according to claim 8, wherein the executable instructions stored in the memory further includes:
ranking the supported network types according to the first mobile country code to obtain a candidate network type after determining that the wireless communication device is in the roaming state ;
obtaining a candidate provider list via obtaining one or more registered public land mobile networks from a second database;
ranking he public land mobile network obtained via the searching result, the candidate network type and the candidate provider list to obtain a registration sequence while executing the search in the candidate network type is finished; and
selecting the public land mobile network and the supported network type with a highest priority in the rank to execute the registration according to the registration sequence.

10. The wireless communication device according to claim 8, wherein the executable instructions stored in the memory further includes:
selectively executing a corresponding step according to a rejection reason of the registration when the wireless communication device fails in the registration;
sequentially selecting next one of the public land mobile network and the supported network type to execute the registration according to the registration sequence when the rejection reason conforms to a preset rejection cause code; and
executing an operation according to a standard specification when the rejection reason does not conform to the preset rejection cause code.
